(19) United States
(12) Patent Application Publication
(10) Pub. No.: US 2025/0322843 A1
(43) Pub. Date: Oct. 16, 2025

(54) MODIFYING FACIAL FEATURE BASED ON SPEECH SIGNAL

(71) Applicant: Google LLC, Mountain View, CA (US)

(72) Inventors: Maruchi Kim, Seattle, WA (US); Dongeek Shin, San Jose, CA (US); Seyed Farbod Taghizadeh Motlagh, Seattle, WA (US)

(21) Appl. No.: 18/633,219

(22) Filed: Apr. 11, 2024

(51) Int. Cl. G10L 25/78; G06T 13/20; G06T 13/40; G10L 15/22

(52) U.S. Cl. CPC G10L 25/78; G06T 13/205; G06T 13/40; G10L 15/22; G10L 2015/227

(57) ABSTRACT

A computer-implemented method can include determining a speech transition within a speech signal, the speech transition including a change of sound; determining a mouth state based on the speech transition; determining a vowel transition during a vowel sound within the speech signal; and modifying a facial feature of an avatar based on the mouth state and the vowel transition.

### BACKGROUND

Users can engage in videoconferences wherein the users are represented by avatars rather than actual video streams of the users. However, facial features of the avatars may not correspond to speech of the users, resulting in an unrealistic representation of the users.

### SUMMARY

To enhance the user experience during videoconferences, a computing system modifies facial features, such as mouth movements, of avatars based on speech of the users. The computing system can modify the facial features based on features of a speech signal, resulting in a realistic representation of the avatar speaking while the user is speaking. The features of a speech signal can include changes of sound during speech transitions and vowel transitions during vowel sounds.

According to an example, a computer-implemented method can include determining a speech transition within a speech signal, the speech transition including a change of sound; determining a mouth state based on the speech transition; determining a vowel transition during a vowel sound within the speech signal; and modifying a facial feature of an avatar based on the mouth state and the vowel transition.

According to an example, a non-transitory computer-readable storage medium can comprise instructions stored thereon. When executed by at least one processor, the instructions can be configured to cause a computing system to: determine a speech transition within a speech signal, the speech transition including a change of sound; determine a mouth state based on the speech transition; determine a vowel transition during a vowel sound within the speech signal; and modify a facial feature of an avatar based on the mouth state and the vowel transition.

According to an example, a computing system can include at least one processor and a non-transitory computer-readable storage medium comprising instructions stored thereon. When executed by the at least one processor, the instructions can be configured to cause the computing system to determine a speech transition within a speech signal, the speech transition including a change of sound; determine a mouth state based on the speech transition; determine a vowel transition during a vowel sound within the speech signal; and modify a facial feature of an avatar based on the mouth state and the vowel transition.

The details of one or more implementations are set forth in the accompanying drawings and the description below. Other features will be apparent from the description and drawings, and from the claims.

### BRIEF DESCRIPTION OF THE DRAWINGS

FIG. 1 shows a first user participating in a videoconference with a second user and a first avatar representing the first user and a second avatar representing the second user.

FIG. 2 shows a speech signal that may be used by a computing system to modify facial features of an avatar.

FIG. 3 shows an example pipeline for modifying facial features of an avatar based on speech signals.

FIG. 4 shows a graph with formant features.

FIG. 5 illustrates example components of mouth-to-ear latency.

FIG. 6 is an example block diagram of a computing system that can modify a facial feature of an avatar based on a speech signal.

FIG. 7 is an example flowchart of a method performed by a computing system.

Like reference numbers refer to like elements.

### DETAILED DESCRIPTION

Computing systems can represent users with avatars during videoconferences rather than presenting live video streams of the users. Representing the users with avatars rather than the live video streams can reduce the data needed to be sent between users. To create a realistic user experience, a computing system can generate a pronunciation mouth shape model based on consonants or phonetic symbols of speech of the users.

A technical problem with the pronunciation mouth shape model based on consonants or phonetic symbols of the speech is that different users have different pronunciations and corresponding facial features for the same consonants or phonetic symbols. Thus, representations of users may not appear realistic. A technical solution to the technical problem of different pronunciations and corresponding facial features for the same consonants or phonetic symbols is to modify facial features based on speech transitions and vowel transitions within a speech signal. A speech transition can include a change of sound, such as a phonemic transition from a vowel sound to a consonant sound, from a consonant sound to a vowel sound, from a vowel sound to a different vowel sound, or from a consonant sound to another consonant sound. The facial transitions can include changing mouth states based on an envelope that is extracted from the speech signal. The vowel transitions can include changes of acoustic resonances during a vowel sound within the speech signal. The acoustic resonances can be resonant frequencies of the vocal tract of the user who is speaking. Acoustic resonances can be changed or enhanced by the user changing a shape of their mouth or throat. A technical benefit to modifying facial features based on speech transitions and vowel transitions within the speech signal is realistic representations of the user speech that are particular to the speech patterns of a particular user.

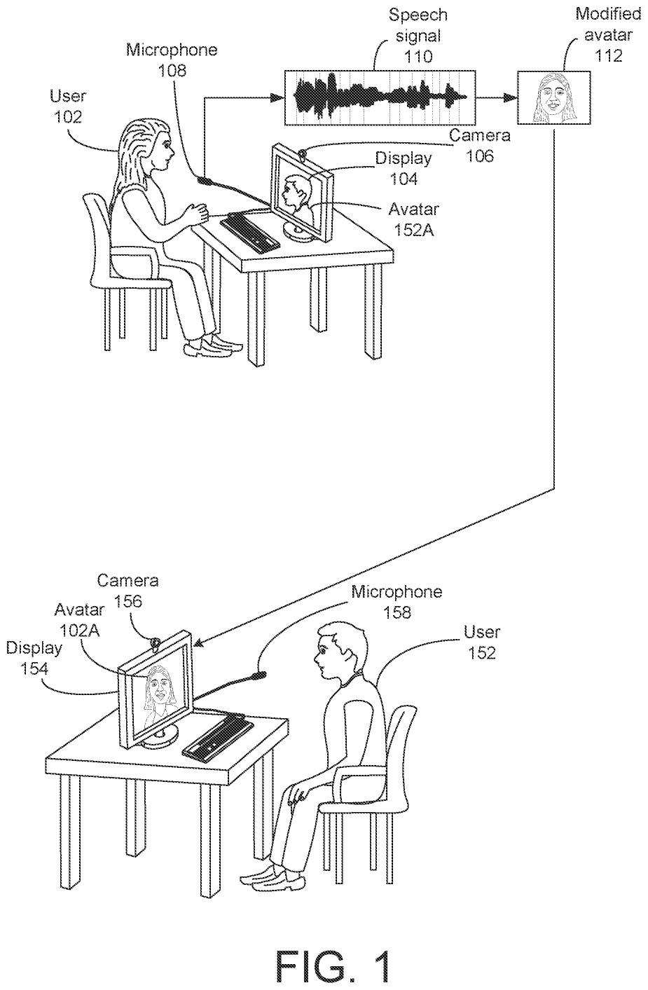

FIG. 1 shows a first user 102 participating in a videoconference with a second user 152 and a first avatar 102A representing the first user 102 and a second avatar 152A representing the second user 152. The first user 102 interacts with a first computing device that includes at least a display 104 and a microphone 108. The first computing device can also include a camera 106. The display 104 can present images, such as a second avatar 152A representing the second user 152. The camera 106 can capture images of the first user 102.

The first computing device, and/or a computing system in communication with the first computing device (such as a server that is facilitating the videoconference), can generate the first avatar 102A to represent the first user 102 rather than presenting a video stream captured by the camera 106. In some examples, the first avatar 102A is based on images of the first user 102. In some examples, the first avatar 102A was selected by the first user 102 and may not have a similar appearance to the first user 102. A display 154 included in a second computing device that the second user 152 is interacting with can present the first avatar 102A.

The microphone 108 can capture a speech signal 110 based on speech and/or words spoken by the first user 102. The speech signal 110 can include sounds spoken by the first user 102 during the videoconference with the second user 152. The speech signal 110 can include one or more changes of sound. Changes of sound can include transitions between different phonemes, transitions from a vowel sound to a consonant sound or from a consonant sound to a vowel sound, and/or a vowel transition during a vowel sound. A phoneme can include a perceptually distinct unit of sound in a language that distinguishes one word from another. The sounds of the letters p, b, d, and t in the English words pad, pat, bad, and bat are examples of phonemes.

While FIG. 1 shows a microphone 108 included in a computing device resting on a table, this is merely an example. In some examples, a microphone that captures audio input from the first user 102 can be included in a head-mounted device such as a virtual reality headset or augmented reality headset that also includes a display and speaker.

A computing system, which can include the first computing device, and/or a computing system in communication with the first computing device, can generate a modified avatar 112 based on the speech signal 110. The computing system can generate the modified avatar 112 by modifying a facial feature of the avatar that represents the first user 102 based on the speech signal 110. The computing system can, for example, determine a speech transition within the speech signal 110. The computing system can determine a mouth state, such as a mouth open state or mouth closure state (such as open, closed, or a gradual openness), based on the speech transition. The computing system can, for example, determine a vowel transition during a vowel sound within the speech signal 110. The computing system can modify a facial feature of the avatar based on the mouth state and the vowel transition. The computing system can generate the modified avatar 112 based on the modification to the facial feature.

The computing system can send the modified avatar 112 to the second computing device. The second computing device can present the first avatar 102A to the second user 152 via a display 154 included in the second computing device. The second computing device can present the first avatar 102A concurrently with audio based on the speech signal 110 captured by the microphone 108. Mouth movements of the first avatar 102A can correspond to the speech included in the audio outputted by the second computing device. The first avatar 102A can appear to be speaking in a similar manner as a live video stream of the first user 102 while the first user 102 is speaking to the second user 152.

The second user 152 can provide input to the second computing device during the videoconference. The second computing device can include a microphone 158 that captures speech of the second user 152. The second computing device can send the captured speech to the first computing device for the first computing device to output to the first user 102. The second computing device can include a camera 156 that captures images of the second user 152. A computing system, such as the second computing device or a computing system in communication with the second computing device (such as a server facilitating the videoconference), can generate an avatar that represents the second user 152 based on images captured by the camera 156. The computing system can modify the avatar based on speech of the second user 152 and send the modified avatar to the first computing system, enabling the first computing device to present a second avatar 152A on the display 104 to represent the second user 152.

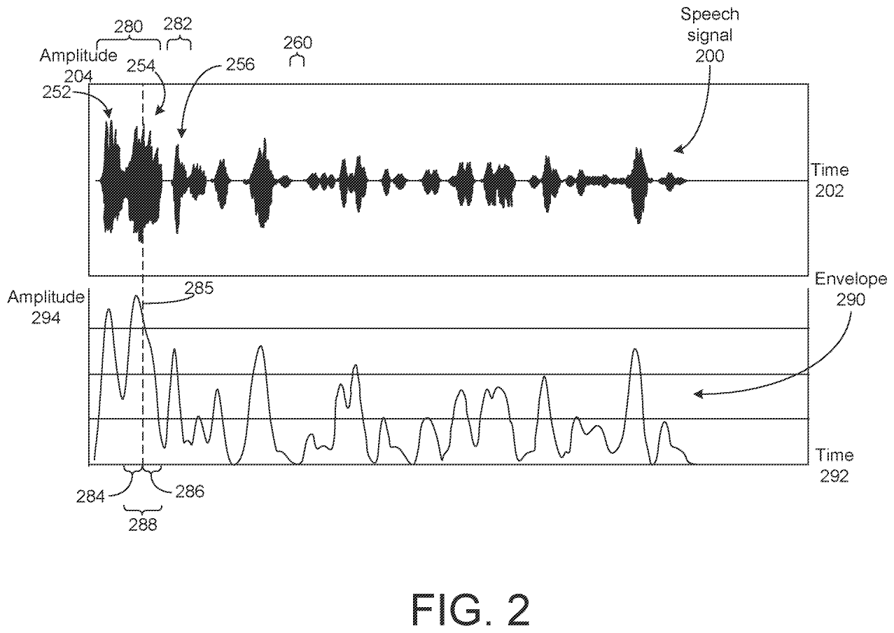

FIG. 2 shows a speech signal 200 that may be used by a computing system to modify facial features of an avatar. The speech signal 200 can be based on audio data captured by a microphone proximal to a user, such as the microphone 108 shown in the example of FIG. 1. The computing system, and/or another computing system in communication with the communication system, can determine and/or generate a speech envelope 290 based on the speech signal 200.

FIG. 2 shows an amplitude 204 of the speech signal 200 as a function of time 202 and an amplitude 294 of the speech envelope 290 as a function of time 292. The speech envelope 290 can have values normalized to a predetermined range, such as between zero (0) and one (1). An envelope of a speech signal is a smooth curve outlining the extremes (or maximum absolute values) of the speech signal and can be used to detect amplitude variations of an audio (speech) signal. An example circuit for detecting an envelope can include a capacitor in parallel with a resistor, and a diode in series with (and allowing current to flow toward) the parallel capacitor and resistor.

In the example shown in FIG. 2, the speech signal 200 and speech envelope 290 are based on speech data from a user such as the first user 102 speaking the words, “Hello this is a test to see if the speech envelope sensing is working.” The speech data may have been captured by the microphone 158. A portion of the speech signal 200 and speech envelope 290 corresponding to the word, “Hello,” is labeled as a first word 280. A portion of the speech signal 200 and speech envelope 290 corresponding to the word, “this,” is labeled as a second word 282. A portion of the speech signal 200 corresponding to a first syllable 252 or phoneme, “hell,” in the first word 280, “hello,” is labeled. A portion of the speech signal 200 corresponding to a second syllable 254 or phoneme, a long “o” sound, in the first word 280, “hello,” is labeled. A portion of the speech signal 200 corresponding to the single syllable 256 or phoneme, “this,” of the second word 282, “this,” is labeled. Corresponding peaks of the speech envelope 290 also correspond to the first syllable 252, second syllable 254, and single syllable 256.

The second syllable 254 includes a vowel transition 288. The vowel transition 288 includes a change of sound while making a same vowel sound. In the example of FIG. 2, the same vowel sound is the long “o” sound. The vowel transition 288 includes a first acoustic resonance 284 as an amplitude 204, 294 of the second syllable 254 increases and a second acoustic resonance 286 as the amplitude 204, 294 of the second syllable 254 decreases. A boundary 285 separates the first acoustic resonance 284 from the second acoustic resonance 286. The first acoustic resonance 284 has a different acoustic resonance than the second acoustic resonance 286.

In some examples, the vowel transition 288 can include a first formant during the vowel sound of the second syllable 254 and a second formant during the vowel sound of the second syllable 254. A formant can be a prominent band of frequency that determines a phonetic quality of a vowel. A formant can include a spectral maximum caused by acoustic resonance of the vocal tract of the user (such as the first user 102) generating the speech based on which the speech signal 200 and speech envelope 290 were generated. The formants can include broad peaks and/or spectral maxima of the speech. The formants can be measured by frequency values such as Hertz. The formants can include distinctive frequency components of the speech signal 200. In the example of FIG. 2, the second syllable 254 and/or vowel transition 288 can include a first formant of 360 Hertz and a second formant of 640 Hertz.

In some examples, a computing system can determine whether a user is talking and/or speaking based on comparing the speech envelope 290 to a talking threshold value, such as determining whether the talking threshold is satisfied based on whether the speech envelope 290 meets or exceeds the talking threshold value. The talking threshold can be an absolute value representing a magnitude (amplitude) value that the speech signal must meet to be considered speech. The talking threshed can be a value measured in decibels, or a relative value measured with respect to a maximum value of the speech (e.g., one (1)). The talking threshold can be a value within the normalized scale of the envelope. The talking threshold value can be a predetermined proportional value, such as 0.05 in an example in which the range of the speech envelope 290 is normalized to a value between a minimum value of zero (0) and a maximum value of one (1). The computing system can determine a mouth closure state for an avatar based on comparing the value of the speech envelope 290 to the talking threshold value. If the user is determined to be talking based on the value of the speech envelope 290 satisfying the talking threshold value, then the computing system can determine that a mouth closure state of the avatar is open and can modify a facial feature of the avatar by opening a mouth of the avatar or keeping a mouth of the avatar open. If the user is determined to not be talking based on the value of the speech envelope 290 not satisfying the talking threshold value, then the computing system can determine that a mouth closure state of the avatar is closed and can modify a facial feature of the avatar by closing the mouth of the avatar or keeping the mouth of the avatar closed.

In some examples, the computing system can return an avatar to a neutral state during a period of silence 260. The computing system can determine a period of silence 260 based on a value of the speech signal 200 and/or speech envelope 290 satisfying a silence threshold, such as being at or below the silence threshold. The neutral state can include a closed mouth and/or lack of facial expression for the avatar.

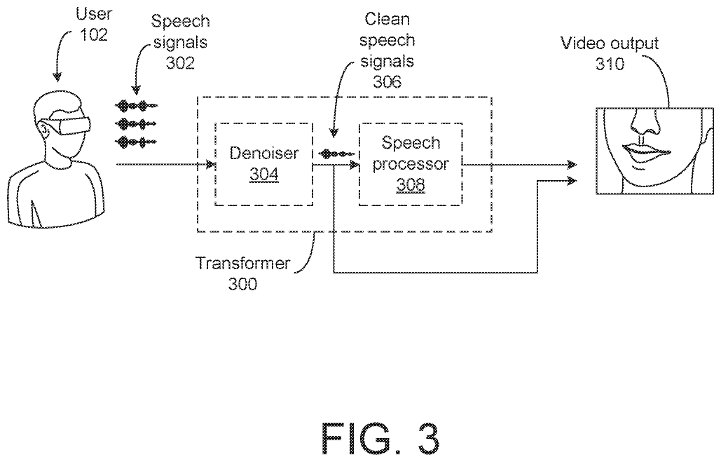

FIG. 3 shows an example pipeline for modifying facial features of an avatar based on speech signals. The pipeline is an example of generating the modified avatar 112 based on the speech signal 110 captured from speech from the first user 102. The pipeline can be included in the computing device that includes the microphone 108 and/or a computing system in communication with the computing device that includes the microphone 108.

The first user 102 can speak in proximity to the microphone 108 (not shown in FIG. 3). The microphone 108 can capture speech signals 302 based on the speech of the first user 102. The speech signal 200 is an example of the speech signals 302 that the microphone 108 can capture.

A transformer 300 can generate video output 310 based on the speech signals 302. The transformer 300 can determine modifications to facial features, such as mouth movements, of an avatar associated with the first user 102 based on the speech signals 302.

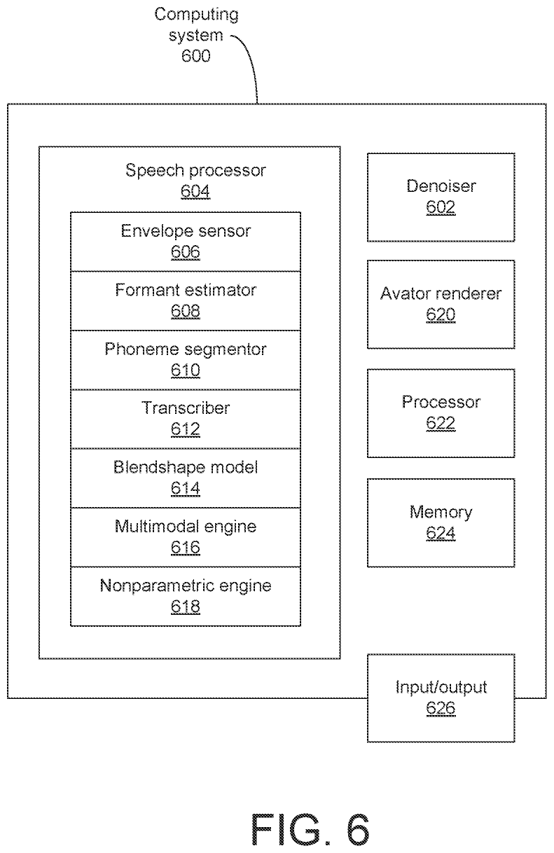

The transformer 300 can include a denoiser 304. The denoiser 304 can remove noise from the speech signals 302. The denoiser 304 can generate clean speech signals 306 by denoising the speech signals 302. The denoiser 304 is an example of the denoiser 602 shown and described with respect to FIG. 6. The denoiser 304 can provide the clean speech signals 306 to a speech processor 308.

The transformer 300 can include the speech processor 308. The speech processor 308 can modify and/or transform facial features, such as features of the lips and/or mouth, of the avatar associated with the first user 102. The speech processor 308 is an example of the speech processor 604 shown and described with respect to FIG. 6. Transformation of the facial features of the avatar can generate a modified avatar such as the modified avatar 112. Multiple transformations of the facial features of the avatar and/or generations of modified avatars can generate sequential frames and/or images that constitute a video of the avatar speaking synchronously with the speech signals 302. Based on the multiple transformations and/or generations of modified avatars, the speech processor 308 of the transformer 300 can provide video output 310 of the modified avatar speaking. The transformer 300 can provide the video output 310 to a computing device such as the second computing device for presentation on the display 154.

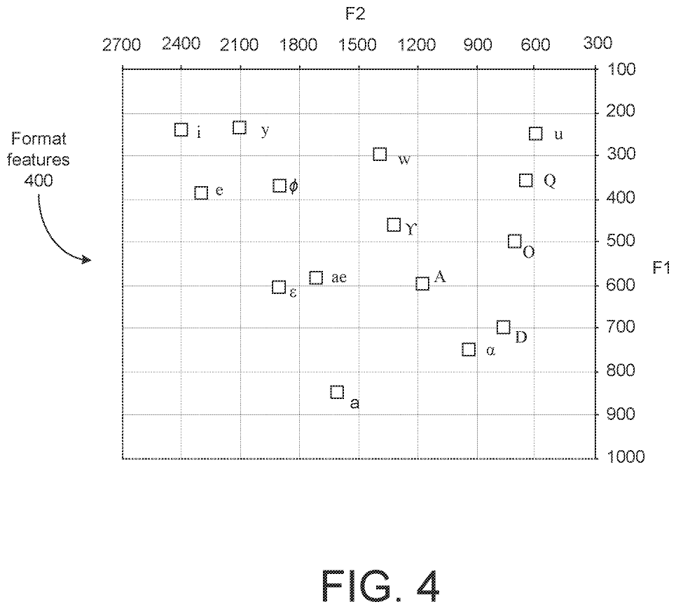

FIG. 4 shows a graph with formant features 400. The formant features 400 capture acoustic resonances of the human vocal tract that generates speech signals. The formant features indicate intra-vowel separation. The computing system can determine a first formant and a second formant for a vowel. A transition from a first formant to a second formant can be included in a vowel transition and can indicate widening or narrowing an opening of a mouth while speaking a vowel sound. The computing system can determine a frequency for the first format (denoted F1 on the vertical axis) and a frequency for the second format (denoted F2 on the horizontal axis). In some examples, the computing system determines the formants and associated frequencies based on the denoised speech and/or clean speech signals (such as clean speech signals 306). In some examples, the computing system determines acoustic resonances, such as the acoustic resonances 284, 286, based on the frequencies associated with the formants. A computing system can determine a first formant (labeled F1 in FIG. 4) and a second formant (labeled F2 in FIG. 4) from captured speech and/or denoised speech. The computing system can compare the first formant and second formant to clusters of previously-determined pairs of formants within a dataset to determine and/or estimate formants of the speech signal and/or speech envelope. The computing system can open (or widen) or close (or narrow) a mouth of the avatar based on a pair of sequential formants that corresponds to the first formant and the second formant. The computing system can widen or narrow an opening of a mouth of an avatar based on the determined and/or estimated formants of the speech signal and/or speech envelope. For example, if the frequency of the second formant increases compared to the frequency of the first formant, the computing system can widen the mouth. If the frequency of the second formant decreases compared to the frequency of the first formant, the computing system can narrow the mouth.

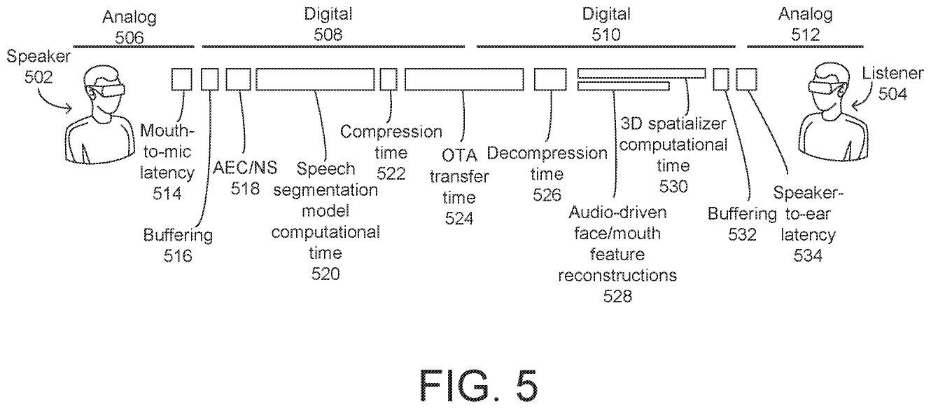

FIG. 5 illustrates example components of mouth-to-ear latency. The latency includes latency from a time when speech is spoken by a speaker 502 to a time when the speech is heard by a listener 504. The first user 102 is an example of the speaker 502. The second user 152 is an example of the listener 504. The latency includes a first analog portion 506 followed by a first digital portion 508, followed by a second digital portion 510, followed by a second analog portion 512. A desired total ear-to-mouth latency is no greater than 150 milliseconds, the latency of Voice over Internet Protocol (VOIP), to enable transformations of the avatar to coincide with arrival of audio voice signals.

The first analog portion 506 of the latency includes mouth-to-microphone latency 514. The mouth-to-microphone latency 514 includes time between generation of sounds of speech (speaking) by the speaker 502 until the speech is captured by a microphone (the microphone 108 is an example of the microphone).

The first digital portion 508 is based on latency at the computing device with which the speaker 502 is interacting, such as the first computing device that the first user 102 is interacting with. The first digital portion 508 can include buffering 516 of the speech signals captured by the microphone. Buffering 516 can include storing the speech signal in memory. The first digital portion 508 can include acoustic echo cancellation and nose suppression (AEC/NS) latency (518). AES/NS can include denoising and/or cleaning the speech signal. The first digital portion 508 can include speech segmentation model computation time 520. The speech segmentation model computation time 520 can include the first computing device and/or computing system in communication with the first computing device determining speech transitions, vowel transitions, phonemic transitions, acoustic resonances, a speech envelope, formants, consonant features, vowel features, phonemes, and/or predetermined sounds. The first digital portion 508 can include compression time 522. The compression time 522 can include time for the first computing device and/or computing system in communication with the first computing device to compress the speech segmentation model to reduce the data to represent and/or transmit the speech segmentation model.

Transfer time 524 can be included in either or both of the first digital portion 508 and/or second digital portion 510. The transfer time 524 can be considered over-the-air (OTA) transfer time. The transfer time 524 can include time to transfer the compressed data from the first computing device and/or computing system which is in communication with the first computing device to the second computing device with which the listener 504 is interacting. The transfer time 524 can include time to transfer the compressed data via a network such as the Internet.

The second digital portion 510 is based on latency at the computing device with which the listener 504 is interacting. The second digital portion 510 can include decompression time 526. The decompression time 526 can include time for the second computing device with which the listener 504 is interacting to decompress the compressed data received from the first computing device. The second digital portion 510 can include audio-driven facial feature reconstruction 528. The audio-driven facial feature reconstruction 528 can include modifying a facial feature of the avatar representing the speaker 502 based on the decompressed speech signal. The second digital portion 510 can include three-dimensional spatial computation time 530. The three-dimensional spatial computation time 530 can include rendering the modified avatar for presentation on a two-dimensional display (such as the display 154) based on a three-dimensional model for which the facial feature was modified based on the decompressed speech signal. In some examples, a portion of the audio-driven facial feature reconstruction 528 overlaps with the three-dimensional spatial computation time 530 and/or a portion of the three-dimensional spatial computation time 530 overlaps with the audio-driven facial feature reconstruction 528. The second digital portion 510 includes buffering 532 the decompressed speech signal and/or rendered avatar. The second computing device can generate audio output of the speech and video output of the modified avatar.

The second analog portion 512 can include a speaker-to-ear latency 534. The speaker-to-ear latency 534 can include time for a speaker in the second computing device to generate the audio signal(s) and/or time for the audio signal to reach the ear(s) of the listener 504. Latency of speech and video from the speaker 502 to the listener 504 can include a sum of the first analog portion 506, first digital portion 508, second digital portion 510, and second analog portion 512.

FIG. 6 is an example block diagram of a computing system 600 that can modify a facial feature of an avatar based on a speech signal. The computing system 600 can perform any combination of methods, functions, and/or techniques described herein. In some examples, the computing system 600 is an example of the computing device that includes the display 104, the camera 106, and/or the microphone 108. In some examples, the computing system 600 is an example of a server that facilitates the videoconference and is in communication with the computing device that includes the display 104, the camera 106, and/or the microphone 108. In some examples, the computing system 600 represents a distributed system that includes the computing device and the server in communication with the computing device and any other computing devices.

The computing system 600 can include a denoiser 602. The denoiser 602 can have similar features and/or functionalities as the denoiser 304. The denoiser 602 can remove noise from audio files and/or audio signals that include speech and/or speech signals, such as speech signal 110, speech signal 200, and/or speech signals 302. The denoiser 602 can remove the noise (which can include sound other than speech, distortions, and/or artifacts included in the audio signal) while enhancing quality and intelligibility of the speech. In some examples, the denoiser 602 performs spectral subtraction by estimating a noise profile and subtracting the noise profile from the audio signal. In some examples, the denoiser 602 performs Wiener filtering by estimating a noise power spectrum, computing Wiener filter coefficients, and applying a Wiener filter (that includes the Winer filter coefficients) to the noisy spectrum to enhance clean speech components while attenuating the noise. In some examples, the denoiser 602 employs a deep learning-based approach to remove noise from the audio signal, such as a Wave-U-Net audio source separation and denoising model, a Speech Enhancement Generative Adversarial Network (SEGAN) that uses a discriminator network to distinguish between real and enhanced audio to encourage a generator network to produce high-quality denoised speech, and/or DeepXi that leverages a combination of convolutional neural networks and recurrent neural networks to learn complex temporal and spectral patterns in audio signals.

The computing system 600 can include a speech processor 604. The speech processor 604 can have similar features and/or functionalities as the speech processor 308. The speech processor 604 can determine modifications to facial features, such as modifications to a mouth of an avatar, based on received speech. In some examples, the speech processor 604 determines modifications to facial features based on denoised speech received from the denoiser 602.

The speech processor 604 can include an envelope sensor 606. The speech processor 604 can extract, sense, and/or determine a speech envelope, such as the speech envelope 290, based on a speech signal such as the speech signal 200. The envelope sensor 606 can extract, sense, and/or determine the speech envelope by rectifying the speech signal and low-pass filtering the result of the rectification, identifying local extrema and fitting the identified local extrema with low-order functions like polynomials or splines, or performing a Hilbert transformation on the speech signal, as non-limiting examples. The envelope sensor 606 can modify a facial feature of an avatar based on the speech envelope by, for example, opening (or widening) a mouth of the avatar when the value of the speech envelope is high, and closing (or narrowing) the mouth of the avatar when the value of the speech envelope is low. In some examples, the envelope sensor 606 can continuously modify a mouth closure state of the avatar based on the value of the speech envelope, such as by opening the mouth to a size or breadth based on the value of the speech envelope. A continuous vowel that is pronounced by a user for an extended time can have a speech envelope peak that is wide and/or has an extended time duration, causing the speech processor 604 to keep the mouth of the avatar open while the vowel is pronounced.

The speech processor 604 can determine phonemic transitions and/or syllabic transitions based on the speech envelope. In some examples, the speech processor 604 determines a transition between a first phoneme and a second phoneme or between a first syllable and a second syllable based on a valley between two peaks within the speech envelope. In some examples, the speech processor 604 determines a transition between a first phoneme and a second phoneme or between a first syllable and a second syllable based on a value of the speech envelope falling below a transition threshold.

The speech processor 604 can include a formant estimator 608. The formant estimator 608 can determine vowel transitions during vowel sounds within a speech signal and/or speech envelope. The formant estimator 608 can, for example, capture acoustic resonances of the vocal tract of the speaker of the speech signal. The acoustic resonances can include intra-vowel separation information. The formant estimator 608 can extract and/or estimate formants from the speech signal and/or speech envelope by computing and/or determining a first formant and a second formant from a speech signal and/or denoised speech signal. The formant estimator 608 can perform a clustering algorithm on the first formant and second formant, comparing the first formant and second formant to a dataset of sequential formants such as a dataset with pre-existing statistics of speech signal values for pairs of formants. The formant estimator 608 can determine which formants the first formant and second formant correspond to by determining clusters that the first formant and second formant are closest to. An example of pairs of values for pairs of formants is shown in FIG. 4. The formant estimator 608 can determine a modification to a facial feature based on the pair of formants that the first formant and second formant are closest to, such as opening (or widening) the mouth during the vowel sound within the speech signal or closing (or narrowing) the mouth during the vowel sound within the speech signal.

The speech processor 604 can include a phoneme segmentor 610. The phoneme segmentor 610 can segment and/or distinguish phonemes within the speech signal and/or speech envelope. The phoneme segmentor 610 can disambiguate consonant features and vowel features. The phoneme segmentor 610 can disambiguate consonant features and vowel features based on a time-domain model and/or spectral-domain model. The speech processor 604 can build the time-domain model and/or spectral-domain model based on the speech signal. In some examples, the phoneme segmentor 610 distinguishes and/or segments the phonemes within the speech signal and/or speech envelope based on a transcription of the speech signal and/or speech envelope. The speech processor 604 can transcribe the speech signal and/or speech envelope into words, syllables, and/or phonemes. In some examples, the phoneme segmentor 610 extracts features from the speech signal and/or speech envelope to recognize and/or segment phonemes using short-term spectral envelope and modulation frequency features. The phoneme segmentor 610 can derive the short-term spectral envelope and modulation frequency features using Frequency Domain Linear Prediction (FDLP). The speech processor 604 can modify a facial feature of the avatar such as by opening and closing a mouth of the avatar based on the phonemes segmented and/or distinguished by the phoneme segmentor 610. The speech processor 604 can map phonemes to changes of facial features. The speech processor 604 can, for example, cause the vocal tract of the avatar to open for phonemes corresponding to vowels sounds (such as opening the mouth or lowering the tongue) and cause the vocal tract of the avatar to partially or fully close for phonemes corresponding to consonant sounds (such as closing the lips for the consonants ‘b,’ ‘m,’ or ‘p,’ narrowing the lips for the consonants ‘f,’ ‘v,’ or ‘s,’ placing the tongue behind the teeth for the consonants ‘d,’ or ‘t,’ or lifting the back of the tongue for the consonants ‘k,’ or, ‘g’).

The speech processor 604 can include a transcriber 612. The transcriber 612 can transcribe the speech signal and/or speech envelope into word tokens. In some examples, the transcriber 612 can transcribe the speech signal and/or speech envelope into phoneme tokens. In some examples, the speech processor 604 can modify the facial features of the avatar such as the mouth of the avatar based on word tokens and/or phoneme tokens into which the transcriber 612 transcribed the speech signal and/or speech envelope. In some examples, the transcriber 612 transcribes the speech signal and/or speech envelope into word tokens by applying an acoustic model that digests soundwaves and translates the soundwaves into phonemes and applies an n-gram model that determines a word based on a previous n words and/or a hidden Markov model that applies statistical models to predict a subsequent word. In some examples, the transcriber 612 transcribes the speech signal and/or speech envelope into word tokens by applying a neural network such as a recurrent neural network that receives the speech signal and/or speech envelope as input and determines the words and/or phonemes based on the speech signal and/or speech envelope. The speech processor 604 can map predetermined sounds based on words to which the transcriber 612 transcribes the speech signal and/or speech envelope to predetermined facial movements. The speech processor 604 can modify the facial features of the avatar such as the mouth of the avatar based on predetermined associations and/or mappings between predetermined facial movements such as mouth movements and the predetermined sounds corresponding to word tokens and/or phoneme tokens.

The speech processor 604 can include a blendshape model 614. The blendshape model 614 can receive as input the avatar representing the user. The blendshape model 614 can include a linear model of facial expression. The blendshape model 614 can apply the linear model to animate the avatar based on modifications to facial features of the avatar. The blendshape model 614 can modify the avatar based on the speech, such as modifying the avatar based on determinations made by the envelope sensor 606, formant estimator 608, phoneme segmentor 610, and/or transcriber 612. The blendshape model 614 can generate facial poses and/or modify facial features as a linear combination of multiple facial expressions. The facial expressions based on which the blendshape model 614 modifies facial features can include mouth shapes associated with sounds (such as phonemes and/or formants) included in and/or identified within the speech signal and/or speech envelope. The blendshape model 614 can output the modified avatar for presentation by the remote computing device.

The 604 can include a multimodal engine 616. The multimodal engine 616 can modify facial features of the avatar, such as features of the mouth of the avatar, based on both microphone signals (such as speech signals) and movement and/or acceleration signals (such as signals received from an inertial measurement unit (IMU)). The IMU can be included in a head-mounted device worn by a user, such as the first user 102 who is generating the speech signals. The IMU can measure movement and/or acceleration of a head of the user. The multimodal engine 616 can reconstruct facial features, such as parametric mouth landmarks, based on the microphone signals and movement and/or acceleration signals. The multimodal engine 616 can, for example, rotate the head of the avatar in a direction corresponding to the rotation of the head of the user (as determined based on the movement measurement and/or acceleration measurement of the head of the user performed by the IMU).

The speech processor 604 can include a nonparametric engine 618. The nonparametric engine 618 can perform non-parametric rendering of facial features of the avatar, such as non-parametric rendering of a mouth of the avatar. The nonparametric engine 618 can append keypoints to the face of the avatar.

The computing system 600 can include an avatar renderer 620. The avatar renderer 620 can render the avatar based on changes to facial features of the avatar determined by the speech processor 604. The avatar renderer 620 can generate a modified avatar, such as the modified avatar 112 and/or first avatar 102A, based on the changes to facial features of the avatar determined by the speech processor 604.

The computing system 600 can include at least one processor 622. The at least one processor 622 can execute instructions, such as instructions stored in at least one memory device 624, to cause the computing system 600 to perform any combination of methods, functions, and/or techniques described herein.

The computing system 600 can include at least one memory device 624. The at least one memory device 624 can include a non-transitory computer-readable storage medium. The at least one memory device 624 can store data and instructions thereon that, when executed by at least one processor, such as the processor 622, are configured to cause the computing system 600 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 600 can be configured to perform, alone, or in combination with the computing system 600, any combination of methods, functions, and/or techniques described herein.

The computing system 600 may include at least one input/output node 626. The at least one input/output node 626 may receive and/or send data, such as from and/or to, a server or other computing device, and/or may receive input and provide output from and to a user. The input and output functions may be combined into a single node, or may be divided into separate input and output nodes. The input/output node 626 can include a microphone (such as the microphone 108 or microphone 158), a camera (such as the camera 106 or camera 156), a display (such as the display 104 or display 154), a speaker, one or more buttons (such as a keyboard), a human interface device such as a mouse or trackpad, and/or one or more wired or wireless interfaces for communicating with other computing devices such as a server and/or the computing devices that captured images of the user 102, 152.

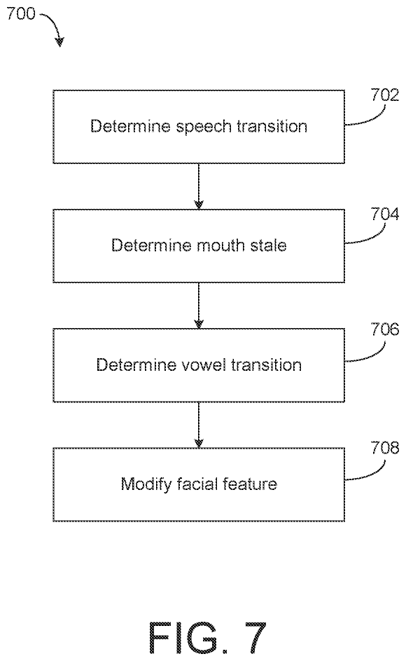

FIG. 7 is an example flowchart of a method 700 performed by a computing system. The method can be a computer-implemented method performed by the computing system 600.

The method 700 can include determining a speech transition (702). Determining a speech transition (702) can include determining a speech transition within a speech signal, the speech transition including a change of sound. The method 700 can include determining a mouth state (704). Determining a mouth state (704) can include determining a mouth state based on the speech transition. The method 700 can include determining a vowel transition (706). Determining a vowel transition (706) can include determining a vowel transition during a vowel sound within the speech signal. The method 700 can include modifying a facial feature (708). Modifying a facial feature (708) can include modifying a facial feature of an avatar based on the mouth state and the vowel transition.

In some examples, the speech transition includes a phonemic transition.

In some examples, the vowel transition includes a first acoustic resonance within the speech signal and a second acoustic resonance within the speech signal, the first acoustic resonance having a different resonant frequency than the second acoustic resonance.

In some examples, determining the mouth state includes extracting an envelope from the speech signal and comparing a value of the envelope to a talking threshold value. The mouth state can be open when the value of the envelope satisfies the talking threshold value.

In some examples, determining the vowel transition includes determining a first formant during the vowel sound within the speech signal, determining a second formant during the vowel sound within the speech signal, and comparing the first formant and the second formant to a dataset of sequential formants to identify a pair of sequential formants that corresponds to the first formant and the second formant, wherein the vowel transition corresponds to the pair of sequential formants.

In some examples, the method 700 further includes identifying a consonant feature within the speech signal and identifying a vowel feature within the speech signal. Modifying the facial feature can include modifying the facial feature based on the mouth state, the vowel transition, the consonant feature, and the vowel feature.

In some examples, the method 700 further includes transcribing a first phoneme within the speech signal and transcribing a second phoneme within the speech signal. Modifying the facial feature can include modifying the facial feature based on the mouth state, the vowel transition, the first phoneme, and the second phoneme.

In some examples, the method 700 further includes identifying a predetermined sound within the speech signal and mapping the predetermined sound to a predetermined facial movement. Modifying the facial feature can include modifying the facial feature based on the mouth state, the vowel transition, and the predetermined facial movement.

In some examples, modifying the facial feature includes modifying the facial feature based on the mouth state, the vowel transition, and an acceleration measurement.

In some examples, the method 700 further includes returning the avatar to a neutral state.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the disclosed implementations.

What is claimed is:

1. A computer-implemented method, the method comprising:
determining a speech transition within a speech signal, the speech transition including a change of sound;
determining a mouth state based on the speech transition;
determining a vowel transition during a vowel sound within the speech signal; and
modifying a facial feature of an avatar based on the mouth state and the vowel transition.

2. The method of claim 1, wherein the speech transition includes a phonemic transition.

3. The method of claim 1, wherein the vowel transition includes a first acoustic resonance within the speech signal and a second acoustic resonance within the speech signal, the first acoustic resonance having a different resonant frequency than the second acoustic resonance.

4. The method of claim 1, wherein determining the mouth state includes:
extracting an envelope from the speech signal; and
comparing a value of the envelope to a talking threshold value,
wherein the mouth state is open when the value of the envelope satisfies the talking threshold value.

5. The method of claim 1, wherein determining the vowel transition includes:
determining a first formant during the vowel sound within the speech signal;
determining a second formant during the vowel sound within the speech signal; and
comparing the first formant and the second formant to a dataset of sequential formants to identify a pair of sequential formants that corresponds to the first formant and the second formant, wherein the vowel transition corresponds to the pair of sequential formants.

6. The method of claim 1, further comprising:
identifying a consonant feature within the speech signal; and
identifying a vowel feature within the speech signal,
wherein modifying the facial feature includes modifying the facial feature based on the mouth state, the vowel transition, the consonant feature, and the vowel feature.

7. The method of claim 1, further comprising:
transcribing a first phoneme within the speech signal; and
transcribing a second phoneme within the speech signal,
wherein modifying the facial feature includes modifying the facial feature based on the mouth state, the vowel transition, the first phoneme, and the second phoneme.

8. The method of claim 1, further comprising:
identifying a predetermined sound within the speech signal; and
mapping the predetermined sound to a predetermined facial movement,
wherein modifying the facial feature includes modifying the facial feature based on the mouth state, the vowel transition, and the predetermined facial movement.

9. The method of claim 1, wherein modifying the facial feature includes modifying the facial feature based on the mouth state, the vowel transition, and an acceleration measurement.

10. The method of claim 1, further comprising returning the avatar to a neutral state.

11. A non-transitory computer-readable storage medium comprising instructions stored thereon that, when executed by at least one processor, are configured to cause a computing system to:
determine a speech transition within a speech signal, the speech transition including a change of sound;
determine a mouth state based on the speech transition;
determine a vowel transition during a vowel sound within the speech signal; and
modify a facial feature of an avatar based on the mouth state and the vowel transition.

12. The non-transitory computer-readable storage medium of claim 11, wherein the speech transition includes a phonemic transition.

13. The non-transitory computer-readable storage medium of claim 11, wherein the vowel transition includes a first acoustic resonance within the speech signal and a second acoustic resonance within the speech signal, the first acoustic resonance having a different resonant frequency than the second acoustic resonance.

14. The non-transitory computer-readable storage medium of claim 11, wherein determining the mouth state includes:
extracting an envelope from the speech signal; and
comparing a value of the envelope to a talking threshold value,
wherein the mouth state is open when the value of the envelope satisfies the talking threshold value.

15. The non-transitory computer-readable storage medium of claim 11, wherein determining the vowel transition includes:
determining a first formant during the vowel sound within the speech signal;
determining a second formant during the vowel sound within the speech signal; and
comparing the first formant and the second formant to a dataset of sequential formants to identify a pair of sequential formants that corresponds to the first formant and the second formant, wherein the vowel transition corresponds to the pair of sequential formants.

16. A computing system comprising:
at least one processor; and
a non-transitory computer-readable storage medium comprising instructions stored thereon that, when executed by the at least one processor, are configured to cause the computing system to:
determine a speech transition within a speech signal, the speech transition including a change of sound;
determine a mouth state based on the speech transition;
determine a vowel transition during a vowel sound within the speech signal; and
modify a facial feature of an avatar based on the mouth state and the vowel transition.

17. The computing system of claim 16, wherein the speech transition includes a phonemic transition.

18. The computing system of claim 16, wherein the vowel transition includes a first acoustic resonance within the speech signal and a second acoustic resonance within the speech signal, the first acoustic resonance having a different resonant frequency than the second acoustic resonance.

19. The computing system of claim 16, wherein determining the mouth state includes:
extracting an envelope from the speech signal; and
comparing a value of the envelope to a talking threshold value,
wherein the mouth state is open when the value of the envelope satisfies the talking threshold value.

20. The computing system of claim 16, wherein determining the vowel transition includes:
determining a first formant during the vowel sound within the speech signal;
determining a second formant during the vowel sound within the speech signal; and
comparing the first formant and the second formant to a dataset of sequential formants to identify a pair of sequential formants that corresponds to the first formant and the second formant, wherein the vowel transition corresponds to the pair of sequential formants.
